(19) United States
(12) Patent Application Publication
(10) Pub. No.: US 2010/0110407 A1
(43) Pub. Date: May 6, 2010

(54) ILLUMINATION OPTICAL SYSTEM AND EXPOSURE APPARATUS

(75) Inventor: Daisuke Kobayashi, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/609,368

(22) Filed: Oct. 30, 2009

(30) Foreign Application Priority Data
Oct. 31, 2008 (JP) 2008-281309

(51) Int. Cl. G03B 27/72

(52) U.S. Cl. 355/71; 355/77

(57) ABSTRACT

An illumination optical system includes a diffractive optical element configured to convert a light intensity distribution, an optical integrator configured to uniformly illuminate a surface to be illuminated using light that has passed the diffractive optical element, a light shield member arranged at or near a Fourier transform plane between the optical integrator and the diffractive optical element, which has an optically Fourier transformation relationship with the diffractive optical element. The light shield member includes an aperture portion and a light shield portion. A border between the aperture portion and the light shield portion is set to a position having a light intensity of 0 and corresponding to a leading edge of a light intensity distribution formed on the Fourier transform plane by ±1st order diffracted light of the diffractive optical element.

### BACKGROUND OF THE INVENTION

1. Field of the Invention

The present invention relates to an illumination optical system and an exposure apparatus.

2. Description of the Related Art

It is effective for an improved resolution of an exposure apparatus to illuminate an original using a modified illumination, such as an annular illumination, a dipole illumination, and a quadrupole illumination. See Japanese Patent Laid-Open No. (“JP”) 07-086123. Conventionally, use of a diffractive optical element (“DOE”) for an illumination optical system is a known method for the modified illumination. In order to shield a distribution of a 0-th order light other than a desired light intensity distribution formed by the DOE, it is also known to provide a preventive means (such as a light shield member or a diffusion member) for preventing a forward movement of the 0-th order light of the DOF, near a Fourier transform plane of the DOF (see JP 2006-120675).

However, the distribution other than the desired light intensity distribution is not limited to the 0-th order light distribution formed by the DOF. The DOF generates background light, such as the high order diffracted light and scattering light, which deteriorates the imaging performance, in addition to the desired light intensity distribution. The background light also occurs due to a manufacture error of the DOF, causing the light intensity distribution or the resolving performance of the modified illumination to scatter according to the exposure apparatus.

### SUMMARY OF THE INVENTION

The present invention provides an illumination optical system and an exposure apparatus configured to reduce the influence of the background light.

An illumination optical system according to one aspect of the present invention is configured to illuminate a surface to be illuminated. The illumination optical system includes a diffractive optical element configured to convert a light intensity distribution of light from a light source, an optical integrator configured to uniformly illuminate the surface using light that has passed the diffractive optical element, a light shield member arranged at or near a Fourier transform plane between the optical integrator and the diffractive optical element, which has an optically Fourier transformation relationship with the diffractive optical element. The light shield member includes an aperture portion through which the light from the diffractive optical element transmits, and a light shield portion configured to shield the light from the diffractive optical element. A border between the aperture portion and the light shield portion is set to a position having a light intensity of 0 and corresponding to a leading edge of a light intensity distribution formed on the Fourier transform plane by ±1^{st} order diffracted light from the diffractive optical element.

An exposure apparatus including this illumination optical system and a device manufacturing method using this exposure apparatus also constitute other aspects of the present invention.

Further features of the present invention will become apparent from the following description of exemplary embodiments with reference to the attached drawings.

### BRIEF DESCRIPTION OF THE DRAWINGS

FIG. 1 is a sectional view of an exposure apparatus according to this embodiment.

FIG. 2 is a plane view of a light shield member of the exposure apparatus shown in FIG. 1.

FIG. 3 is a light intensity distribution on a Fourier transform plane in the exposure apparatus shown in FIG. 1.

FIG. 4 is a light intensity distribution on a Fourier transform plane in the exposure apparatus shown in FIG. 1.

FIG. 5 is a light intensity distribution when a border between an aperture portion and a light shield portion of a light shield member is set at a position of U3 in the design light intensity distribution shown in FIG. 3 so as to shield the light outside of U3.

FIG. 6 is a light intensity distribution when the border between the aperture portion and the light shield portion of the light shield member is set at a position of U3 in the actually measured light intensity distribution shown in FIG. 4 so as to shield the light outside of U3.

FIG. 7 is a plane view of a turret mounted with the light shield member shown in FIG. 1.

FIG. 8 is a perspective view of a variation of a light shield member shown in FIG. 1.

### DESCRIPTION OF THE EMBODIMENTS

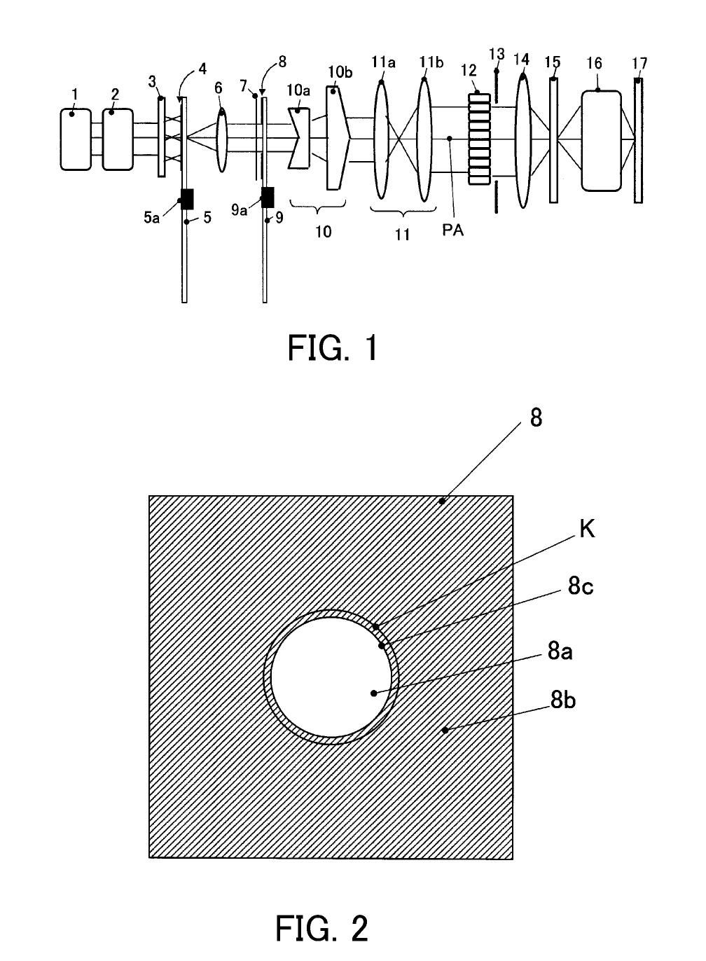

FIG. 1 is a schematic sectional view of an exposure apparatus according to this embodiment. The exposure apparatus includes an illumination optical system (2-14) configured to illuminate an original 15, such as a mask and a reticle, using light from a light source 1, and a projection optical system 16 configured to project an image of a pattern of the original 15 onto a substrate 17, such as a mask and a reticle. The exposure apparatus of this embodiment is a step-and-scan type exposure apparatus, but the present invention is applicable to a step-and-repeat exposure apparatus.

The light source 1 uses an excimer laser or a mercury lamp configured to generate the light (or light beam).

The illumination optical system includes a beam delivery optical system 2, an exit angle reservation optical element 3, a diffractive optical element (“DOE”) 4, a condenser lens 6, a light shield member 8, a prism unit 10, a zoom lens unit 11, and a multi-beam producer 12, a stop 13, and a condenser lens 14.

The beam delivery optical system 2 is provided between the light source 1 and the exit angle reservation optical element 3, and guides the light from the light source 1 to the exit angle reservation optical element 3. The exit angle reservation optical element 3 is provided on the light source side of the DOE 4, includes an optical integrator, such as a micro lens array or a fiber bundle, and guides the light from the light source 1 to the DOE 4 while maintaining its divergence angle. Thereby, the influence of an output fluctuation of the light source 1 on the pattern distribution formed by the DOE 4 can be mitigated.

The DOE 4 is arranged on a plane conjugate with the original 15 as a surface to be illuminated or a plane that has a Fourier transformation relationship with a pupil plane of the illumination optical system. The DOE 4 converts a light intensity distribution of the light from the light source 1 through a diffraction effect, and forms a desired light intensity distribution on the pupil plane of the illumination optical system conjugate with a pupil plane 16a of the projection optical system 16 and a plane conjugate with the pupil plane of the illumination optical system. The DOE 4 may use a computer generated hologram designed by a computer which provides a desired diffraction pattern on a diffraction patterned plane. The light source shape formed on the pupil plane of the projection optical system 16 is referred to as an effective light source shape. The DOE 4 is provided between the exit angle reservation optical element 3 and the condenser lens 6.

The illumination optical system includes a plurality of DOEs 4, each of which is attached to one of a plurality of slots in the turret 5 and mounted onto the turret 5. The plurality of DOEs 4 can form different effective light source shapes. These effective light source shapes include a relatively small circular shape, a relatively large circular shape, an annular shape, a dipole shape, a quadrupole shape, and another shape. An illumination using such an effective light source shape as the annular shape, the dipole shape, and the quadrupole shape, is referred to as the modified illumination.

The turret 5 serves as a first selector configured to selectively arrange one of a plurality of DOEs on an optical path. An actuator 5a is a first driver connected to the turret 5 and configured to rotate the turret 5. As a result, the light beam from the exit angle reservation optical element 3 illuminates the DOE 4, is deflected by the DOE 4, and is guided to the condenser lens 6.

The condenser lens 6 is provided between the DOE 4 and a first prism 10a, condenses the light beam diffracted by the DOE 4, and forms a diffraction pattern on a Fourier transform plane 7 that exists between the condenser lens 6 and the first prism 10a.

The Fourier transform plane 7 is a plane that is located between the multi-layer producer (optical integrator) 12 and the DOE 4, and has an optically Fourier transformation relationship with the DOE 4. When the DOE 4 located on the optical path is replaced by the actuator 5a, a shape of the diffraction pattern formed on the Fourier transform plane 7 can be varied.

The light shield member 8 is located between the condenser lens 6 and the first prism 10a, and at or near the Fourier transform plane 7. The light shield member 8 is, for example, a stop, a blade, and a filter.

The illumination optical system has a plurality of light shield members 8, each of which is attached to a corresponding one of a plurality of slots in the turret 9 and mounted onto the turret 9. The turret 9 serves as a second selector configured to selectively arrange one of the plurality of light shield members 8 on the optical path in accordance with the DOE 4 selected by the turret 5 (first selector), and. An actuator 9a is a second driver connected to the turret 9 and configured to rotate the turret 9.

FIG. 2 is a plane view of an illustrative structure of the light shield member 8. As shown in FIG. 2, the light shield member 8 has an aperture portion 8a through which the light from the DOE 4 transmits, and a light shield portion 8b configured to shield the light from the DOE 4. Reference numeral 8c denotes a border between the aperture portion 8a and the light shield portion 8b, and the aperture portion 8a is located inside of the border 8c. Reference numeral K denotes a contour of the illumination area formed on the Fourier transform plane 7 for the relatively small circular illumination, and the illumination area is located inside of the contour K. Since the light shield member 8b is a hatched area in FIG. 2, an area between the contour K and the border 8c is a range that shields the illumination region formed on the Fourier transform plane 7.

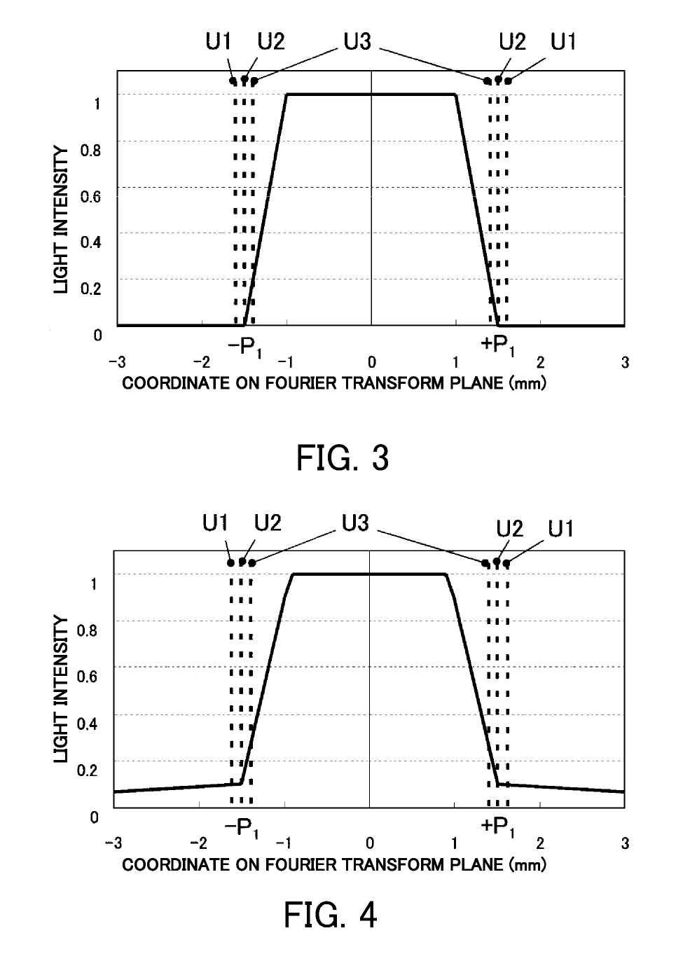

This embodiment sets the border 8c at a position having a light intensity of 0 (or substantially 0) and corresponding to a leading edge of the light intensity distribution formed on the Fourier transform plane 7 by ±1st order diffracted light of the DOE 4. In this embodiment, the leading edge position accords with the position of the light intensity of 0. Initially, a design value of a light intensity distribution on the Fourier transform plane 7 is calculated. FIG. 3 shows a design light intensity distribution on the Fourier transform plane 7 where an optical axis PA (which is an axis perpendicular to the paper plane) is set to an origin. In FIG. 3, an abscissa axis denotes a position on the Fourier transform plane 7 (or a position perpendicular to the paper plane shown in FIG. 1), and an ordinate axis normalizes a maximum value of the light intensity to 1. This light intensity distribution is calculated from the specification of the DOE 4 and an angular distribution of the exit angle reservation optical element 3.

Broken lines U1, U2, and U3 in FIG. 3 are lines perpendicular to the abscissa axis or parallel to the ordinate axis so that intersections with the light intensity distribution are 0, 0, and 0.2. As described above, this embodiment sets the border 8c at a position having a light intensity of 0 and corresponding to the leading edge position of the desired light intensity distribution formed by the DOE 4 on the Fourier transform plane 7 in the design value shown in FIG. 3. This position corresponds to positions of ±1.5 mm (or having an absolute value of 1.5 mm) at which U2 intersects with the light intensity distribution. In addition, an absolute value of the positions at which U1 intersects with the abscissa axis is 1.7 mm, and an absolute value of the position at which U3 intersects with the abscissa axis is 1.3 mm.

As described above, the light shield member 8 may be arranged on or near the Fourier transform plane 7. The elements including the DOE 4 have manufacture errors. When these factors are considered, the border 8c may be located in a predetermined allowable range having a center at a position perfectly corresponding to U2 (or at positions of ±P1 as intersections between U2 and the abscissa axis) rather than being located at that position. This embodiment sets that range to ±2 mm apart from the position coordinate of U2 or a range corresponding to U1-U3, or a range of ±10% of the position coordinate of U2 (having absolute values between 1.35 mm-1.65 mm). The border 8c may be set in this range, and this embodiment considers this range to the position having the light intensity of substantially 0 and corresponding to the leading edge of the light intensity distribution formed on the Fourier transform plane 7.

Although the light intensity distribution shown by FIG. 3 is the design light intensity distribution formed on the Fourier transform plane 7, the actually measured light intensity distribution is as shown in FIG. 4, because the DOE 4 generates the background light and the light intensity around the desired light intensity distribution on the Fourier transform plane 7 is not 0. Broken lines correspond to U1 to U3 shown in FIG. 3 relative to the irradiation distribution shown in FIG. 4.

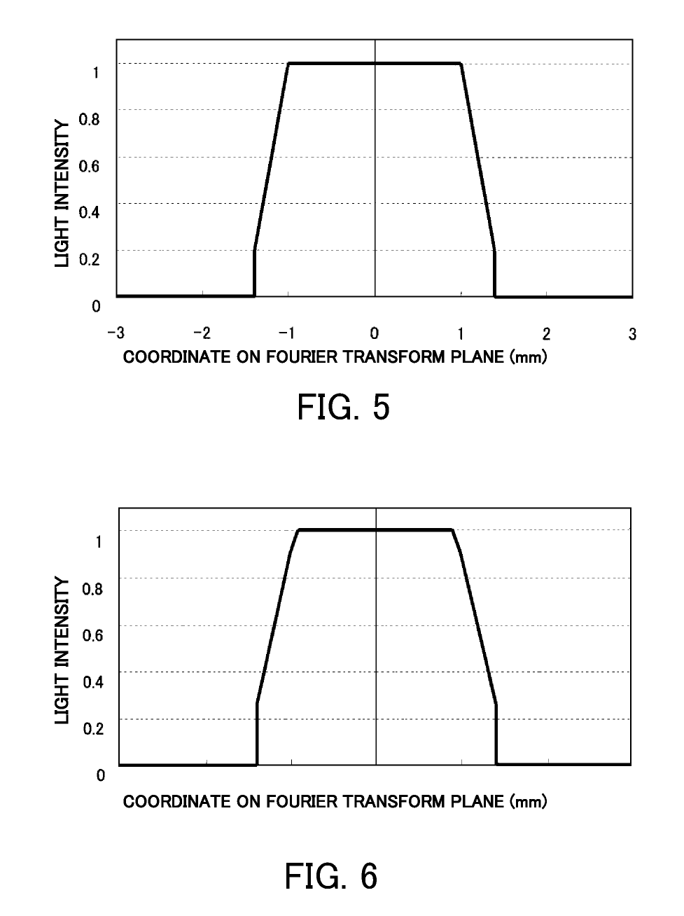

FIG. 5 is a light intensity distribution when the border 8c is set to the position of U3 in the design light intensity distribution shown in FIG. 3 so as to shield the light outside of U3. FIG. 6 shows a light intensity distribution when the border 8c is set to the position of U3 in the actually measured light intensity distribution shown in FIG. 4 so as to shield the light outside of U3. FIG. 5 is substantially equivalent to FIG. 6. They are similarly substantially equivalent to each other even when the border 8c is set to the position of U2. However, when the border 8c is set to the position of U1, the actually measured light intensity distribution shown in FIG. 4 contains a small amount of background light. This amount is negligible and can be absorbed depending upon a distance between the Fourier transform plane 7 and the light shield member 8 or the manufacture error.

As described above, the border 8c is set to the position having the light intensity of substantially 0 and corresponding to a leading edge of the design light intensity distribution formed on the Fourier transform plane 7 by the DOE 4 (or to the above U1-U3 range). Then, the desired light intensity distribution can be maintained while the influence of the background light can be sufficiently restrained. In addition, thereby, a difference of the resolving performance among the exposure apparatuses can be eliminated.

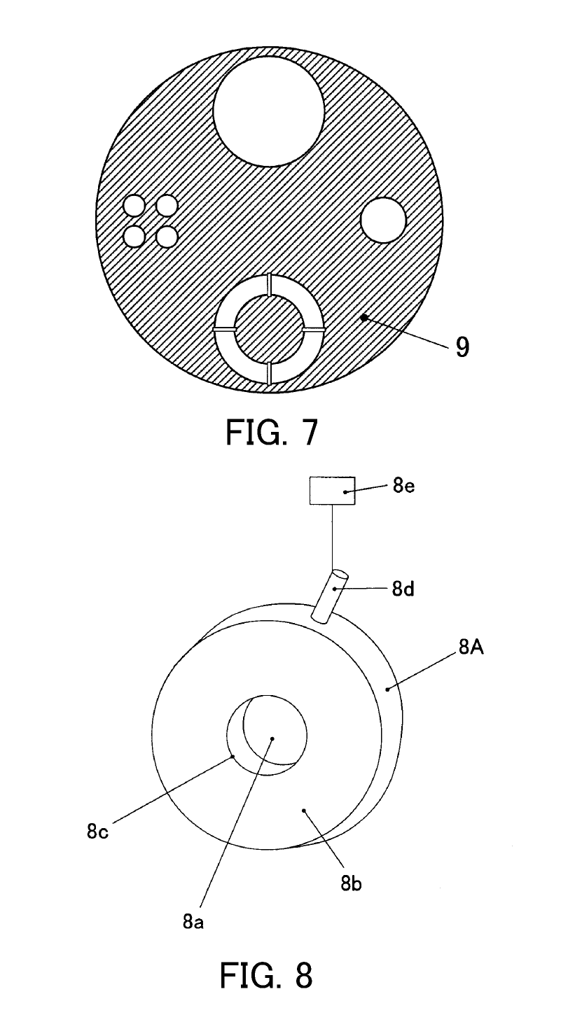

FIG. 7 is a plane view in which a plurality of light shield members 8 are mounted on the turret 9 corresponding to a plurality of DOEs 4. FIG. 7 illustrates four types of light shield members 8 mounted on the turret 9 corresponding to a relatively small circular illumination, a relatively large circular illumination, an annular illumination, and a quadrupole illumination. An illustration of a border between the turret 9 and the extent of each light shield member 8 is omitted.

This embodiment forms a desired light intensity distribution using a plurality of DOEs 4, and shields the background light using a plurality of light shield members 8 corresponding to the DOEs 4, thereby forming a desired effective light source shape while substantially maintaining the illumination efficiency.

When the light shield member 8 is switched in accordance with the DOE 4, an iris stop having a variable aperture diameter may be used for the light shield member 8. For example, as shown in FIG. 8, the light shield member 8 is configured as an iris stop 8A and a lever 8d is rotated by a driver 8e so as to adjust the diameter (or size) of the aperture portion 8a. The lever 8d and the driver 8e constitute a movement unit configured to move the border 8c. Thereby, according to the two DOEs 4 having a relatively small circular shape and a relatively large circular shape, a stop having an optimal shape can be formed by changing a diameter of the light shield member 8. Of course, an movement unit configured to move the border between the inside of the aperture portion and the outside of the aperture portion may be provided for an annular illumination. The movement unit may be provided to the light shield member 8 or to the turret 9. Thus, the illumination optical system may further include a movement unit configured to move the border 8c between the aperture portion 8a and the light shield portion 8b of the light shield member 8, and the movement unit may move the border 8c according to the DOE 4 selected by the turret 5.

The prism unit 10 and the zoom lens unit 11 are provided between the light shield member 8 and the multi-beam producer (optical integrator) 12, and serve as a zoom optical element configured to enlarge a light intensity distribution formed on the Fourier transform plane 7.

More specifically, the prism unit 10 is provided between the Fourier transform plane 7 and the zoom lens unit 11, and includes a first prism 10a and a second prism 10b. The prism unit 10 guides to the zoom lens unit 11a diffraction pattern (light intensity distribution) formed on the Fourier transform plane 7 while the prism unit 10 adjusts its annulus factor and an aperture angle by changing a distance between the first prism 10a and the second prism 10b.

In addition, the zoom lens unit 11 is provided between the prism unit 10 and the multi-beam producer 12, and includes a first lens 11a and a second lens 11b. The zoom lens unit 11 guides a diffraction pattern formed on the Fourier transform plane 7 to the multi-beam producer 12 while the zoom lens unit 11 adjusts a G value that relies upon a ratio between the NA of the illumination optical system and the NA of the projection optical system by changing a distance between the first lens 11a and the second lens 11b.

The multi-beam producer 12 is a fly-eye lens that is provided between the zoom lens unit 11 and the condenser lens 14, and configured to form a multiplicity of secondary light sources and to guide them to the condenser lens 14 in accordance with a diffraction pattern in which the annulus factor, the aperture angle, and the σ value are adjusted. The multi-beam producer 12 may be another optical integrator, such as a pipe, a DOE, and a micro lens array instead of the fly-eye lens. The multi-beam producer 12 can uniformly illuminate the original 15 that serves as a surface to be illuminated, using the light beam that has passed the DOE 4. The stop 13 is provided between the multi-beam producer 12 and the condenser lens 14.

Since the stop 13 subsequent to the multi-beam producer 12 is conjugate with the light shield member 8 (or since the stop 13 has an optically Fourier transformation relationship with the DOE 4), it is conceivable that the stop 13 serves as the light shield member 8. Since the prism unit 10 and the zoom lens 11 adjust the size of the light beam, the size of the light beam at the position of the stop 13 differs according to the illumination condition. In order to eliminate the influence of the background light on all the illumination conditions settable to the illumination optical system, the number of necessary stops becomes unrealistically enormous, because the different stops are necessary for all of these illumination conditions. In addition, since the diameter of the light beam is relatively large at the position of the stop 13, the exposure apparatus becomes disadvantageously large and expensive. Moreover, since the stop 13 is located near the multi-beam producer 12 and shields part of the light, a difference between off-axis and on-axis performances occurs on the illuminated plane.

On the other hand, when the light shield member 8 is arranged prior to the zoom optical system and subsequent to the Fourier transform plane 7, all the illumination conditions settable to the illumination optical system can be controlled only by switching the light shield member 8 in accordance with the DOE 4. In addition, since the light beam diameter is relatively small, the light shield member 8 becomes relatively small. Moreover, only unnecessary background light can be shielded without generating a difference of on-axis and off-axis effective light sources.

The condenser lens 14 is provided between the multi-beam producer 12 and the original 15. Thereby, a multiplicity of light beams guided from the multi-beam producer 12 are condensed and superimposed so as to illuminate the original 15.

The original 15 is provided between the condenser lens 14 and the projection optical system 16, and has a circuit pattern to be transferred. The original 15 is supported and driven by an original stage (not shown). The projection optical system 16 is provided between the original 15 and the substrate 17, and maintains an optically conjugate relationship between them. The substrate 17 is supported and driven by a substrate stage (not shown).

In operation, the illumination optical system illuminates the original 15, and the projection optical system 16 projects an image of the pattern of the original 15 onto the substrate 17. The resolution of the pattern of the original 15 depends upon the effective light source shape, and the light shield member 8 shields the background light and forms the desired effective light source. Therefore, the resolution of the pattern improves. In addition, a method for manufacturing a device, such as a semiconductor integrated circuit device and a liquid crystal display, includes the step of exposing the photosensitive agent applied substrate using the exposure apparatus, and the step of developing the substrate, and the other known steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-281309, filed Oct. 31, 2008, which is hereby incorporated by reference herein in its entirety.

What is claimed is:

1. An illumination optical system configured to illuminate a surface to be illuminated, the illumination optical system comprising:
a diffractive optical element configured to convert a light intensity distribution of light from a light source;
an optical integrator configured to uniformly illuminate the surface using light that has passed the diffractive optical element;
a light shield member arranged at or near a Fourier transform plane between the optical integrator and the diffractive optical element, which has an optically Fourier transformation relationship with the diffractive optical element,
wherein the light shield member includes an aperture portion through which the light from the diffractive optical element transmits, and a light shield portion configured to shield the light from the diffractive optical element, and
wherein a border between the aperture portion and the light shield portion is set to a position having a light intensity of 0 and corresponding to a leading edge of a light intensity distribution formed on the Fourier transform plane by ±1^{st} order diffracted light from the diffractive optical element.

2. The illumination optical system according to claim 1, wherein there are a plurality of diffractive optical elements configured to form different effective light source shapes, and a plurality of light shield members,
wherein the illumination optical system further comprises:
a first selector configured to selectively arrange one of the plurality of diffractive optical elements on an optical path; and
a second selector configured to selectively arrange one of the plurality of light shield members on the optical path, which corresponds to the diffractive optical element selected by the first selector.

3. The illumination optical system according to claim 1, wherein there are a plurality of diffractive optical elements configured to form different effective light source shapes,
wherein the illumination optical system further comprises:
a first selector configured to selectively arrange one of the plurality of diffractive optical elements on an optical path; and
a movement unit configured to move a border between the aperture portion and the light shield portion of the light shield member in accordance with the diffractive optical element selected by the first selector.

4. The illumination optical system according to claim 1, further comprising a zoom optical system provided between the light shielding member and the optical integrator, and configured to enlarge the light intensity distribution formed on the Fourier transform plane.

5. An exposure apparatus comprising:
an illumination optical system configured to illuminate an original; and
a projection optical system configured to project an image of a pattern of the original onto a substrate,
wherein an illumination optical system includes:
a diffractive optical element configured to convert a light intensity distribution of light from a light source;
an optical integrator configured to uniformly illuminate the original using light that has passed the diffractive optical element;
a light shield member arranged at or near a Fourier transform plane between the optical integrator and the diffractive optical element, which has an optically Fourier transformation relationship with the diffractive optical element,
wherein the light shield member includes an aperture portion through which the light from the diffractive optical element transmits, and a light shield portion configured to shield the light from the diffractive optical element, and
wherein a border between the aperture portion and the light shield portion is set to a position having a light intensity of 0 and corresponding to a leading edge of a light intensity distribution formed on the Fourier transform plane by ±1^{st} order diffracted light from the diffractive optical element.

6. A device manufacturing method comprising the steps of:
exposing a substrate using an exposure apparatus; and
developing a substrate that has been exposed,
wherein the exposure apparatus includes:
an illumination optical system configured to illuminate an original; and
a projection optical system configured to project an image of a pattern of the original onto the substrate, includes:
wherein an illumination optical system a diffractive optical element configured to convert a light intensity distribution of light from a light source;
an optical integrator configured to uniformly illuminate the surface using light that has passed the diffractive optical element;
a light shield member arranged at or near a Fourier transform plane between the optical integrator and the diffractive optical element, which has an optically Fourier transformation relationship with the diffractive optical element,
wherein the light shield member includes an aperture portion through which the light from the diffractive optical element transmits, and a light shield portion configured to shield the light from the diffractive optical element, and
wherein a border between the aperture portion and the light shield portion is set to a position having a light intensity of 0 and corresponding to a leading edge of a light intensity distribution formed on the Fourier transform plane by ±1^{st} order diffracted light from the diffractive optical element.
